(19) United States
(12) Patent Application Publication
(10) Pub. No.: US 2002/0039065 A1
(43) Pub. Date: Apr. 4, 2002

(54) Fiber-optic image sensor system for automobile perimeter sensing

(76) Inventor: Lien-Peng Hsiang, Lu-Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/964,560

(22) Filed: Sep. 28, 2001

(30) Foreign Application Priority Data
Sep. 28, 2000 (TW) 089216832

(51) Int. Cl. B60Q 1/00

(52) U.S. Cl. 340/435; 340/436

(57) ABSTRACT

The present invention relates to a fiber-optic image sensor system for automobile perimeter sensing and specifically a sensor system that shows the circumstance of the items on all sides of the vehicle. This sensor system combines a video camera, lens, fiber-optic cable, and display system, and positions a plurality of the fiber-optic cables at appropriate locations on the vehicle that then connect to a camera, which processes the captured images and then connects to the display system inside the vehicle where they are shown.

### BACKGROUND OF THE INVENTION

1. Field of the Invention

The present invention relates to a fiber-optic image sensor system for automobile perimeter, and more particularly a system that can clearly detect objects around the perimeter of a vehicle by capturing images with fiber-optics, and then process those images with a video camera and show them on the screen of a display system in order to provide the driver with a fiber-optic image sensor system with the ability to accurately judge the objects around the perimeter of the vehicle, increase driving safety, avoid collision with objects surrounding the vehicle, and prevent the occurrence of danger or accidents.

2. Description of the Prior Art

As ownership rates for automobiles grow year after year, automobiles have become an important transportation tool integral to daily living. Streets and roads are covered with automobiles as mankind continues to choose them as their primary means of transportation. However, automobiles are large, and when drivers turn and stop and start on roads, streets, alleys and other places, if they are not paying attention or make an omission they often bump into objects such as stones, buckets, boxes, fences, or even small children and elderly people. After bumping into many objects cars are immediately left with scratches, marks, dents, chipped paint, etc that leave their owners feeling upset. If buildings or people are hit then the problem is far more serious.

Currently in order to deal with the problem of cars bumping into things, cars can be equipped with sonogram sensors that detect whether or not an item is near the perimeter of the car. However, these sonogram sensors are only successful to a limited degree because they have a limited angle for detection, creating “blind zones”. Sonogram sensors are also not highly effective at detecting round pillars. Items such as posts or human legs, etc are undetectable. There is also backup sensor systems used on large vehicles. However these are only suited for use on very large vehicles such as transport trucks, busses, etc and cannot be used by most cars. In addition to that, backup sensor systems pose further problems because the image sensed by backup sensor systems is a mirror image, and therefore software solutions must be specially designed and cannot be applied to other systems, therefore increasing costs.

When drivers totally rely on their vision to check their perimeter for objects they are only able to see one side of the vehicle in detail. Also some drivers place a magnification mirror over their rear view mirror in order to expand view area, but this creates distortion therefore affecting the correct judgment of items behind or to the side of the vehicle. This type of mirror also shakes causing the driver to have a dizzy sensation. The current methods used for sensing the perimeter of automobiles described above demonstrate that they are limiting in many ways and leave much to be desired.

Because automobiles are an important tool relied upon by most people today the present inventor believes that there should be a better system designed to increase driver awareness of the area surrounding automobiles, aid in maintaining proper distance, and avoiding collision with other objects that can cause damage to the automobile itself and other objects, thereby increasing driving safety. Therefore, in order to accomplish this purpose the present inventor has spent many years and gained much experience designing, manufacturing, and selling instruments or tools of this type, investing a great amount of energy and time studying, improving, testing, retesting etc and finally successfully developed the present invention, which is a combination of a filming and display system that completely and perfectly shows the whole area surrounding a vehicle, thereby allowing the driver to understand the circumstances surrounding his/her vehicle and drive more safely.

### SUMMARY OF THE INVENTION

The primary objective of the present invention is installing directly on the vehicle fiber-optic cables, a lens on the end of the fiber-optic cables that captures images and transmits them to the video camera for processing and then to the display system inside the automobile to showing the actual and real details of the surrounding area to the driver.

The second objective of the present invention is to provide a method to twist the fiber-optic lines in a way that allows the captured images to appear in the correct form.

Another objective of the present invention is to allow the display system to show the images captured by the plurality of fiber-optic cables and switch back and forth between these different views.

A further objective of the present invention is for the sensor system to not be influenced by outside conditions such as sunlight or rain so that images captured by the fiber-optic cables and shown on the display system will also not be influenced.

Yet another objective of the present invention is for the lens at the end of the fiber-optic cable to be curved out to increase focus and the scope of images captured so that the sensor provides a larger view.

### BRIEF DESCRIPTION OF THE DRAWINGS

FIG. 1 is an exploded structure view of the fiber-optic cable of the present invention.

FIG. 2 is a perspective view of the image capturing fiber-optic cord of the present invention.

FIG. 3 is a structural view of the twisting method of the fiber-optic cord of the present invention.

FIG. 4 is a simplified perspective view of the connection method for the sensor system of the present invention.

FIG. 5 is a perspective view of installing the sensor system of the present invention on a vehicle.

### DETAILED DESCRIPTION OF THE INVENTION

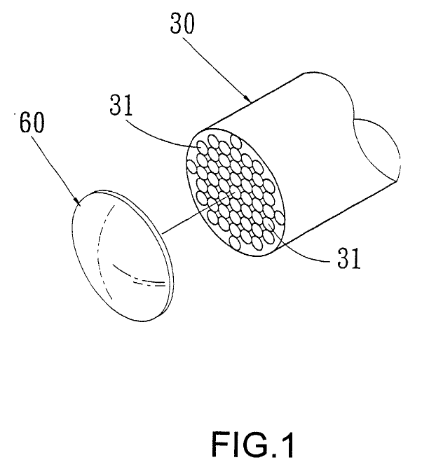

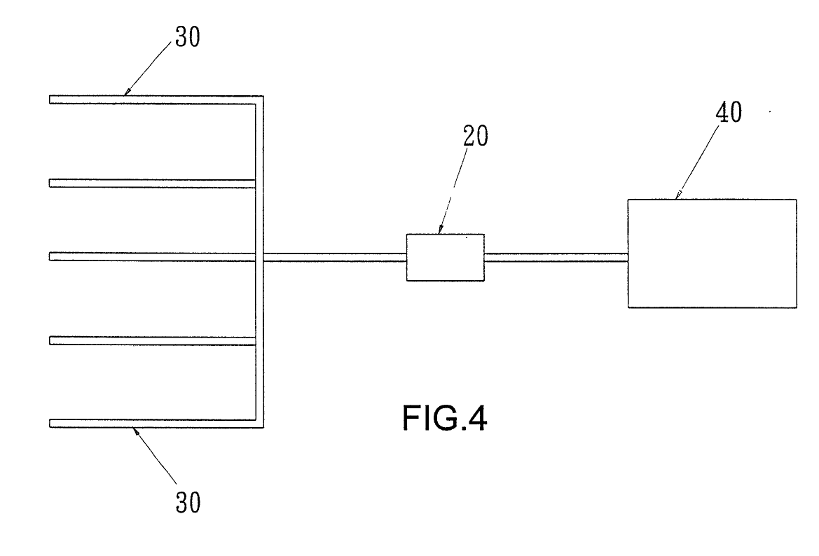

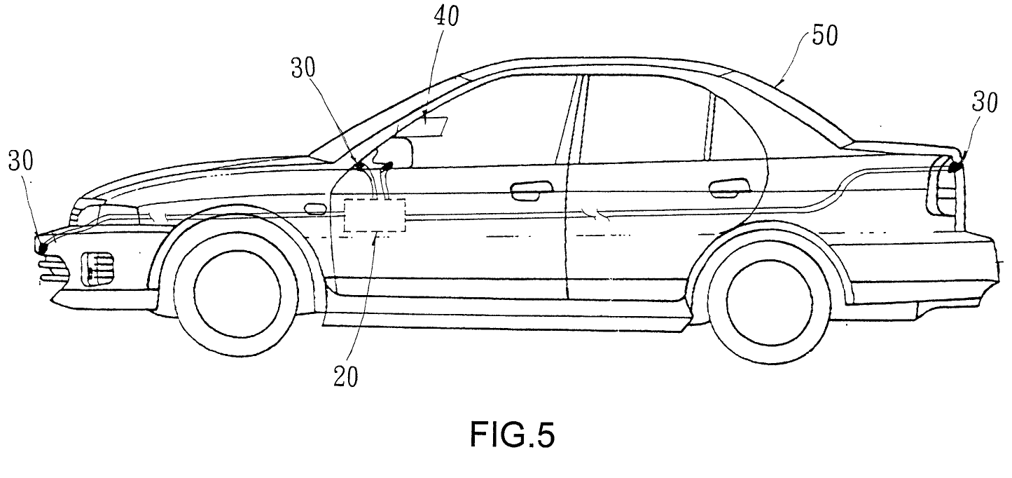

Referring to FIGS. 1, 2, and 4, the sensor system 10 of the present invention is formed from a video camera 20, a fiber-optic cable 30, a display system 40, and an optic lens 60. The use of optic lens 60 at the end of fiber-optic cable 30 improves focus and image capturing results. As illustrated in FIGS. 4 and 5, a plurality of fiber-optic cable 30 and optic lens 60 are appropriately located at different locations on a vehicle 50 and connect to video camera 20, which then connects to the display system inside the vehicle. The images captured by each fiber-optic cable 30 are processed in video camera 20 and then transmitted to display system 40. Thus the driver of vehicle 50 is able to observe the view from locations surrounding vehicle 50 and keep the vehicle from colliding into other objects.

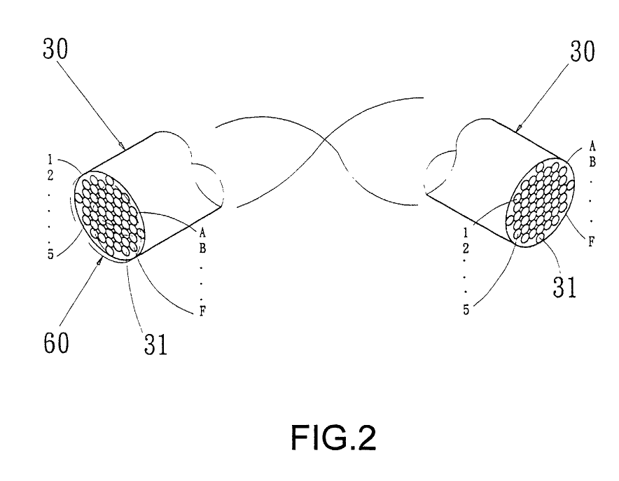

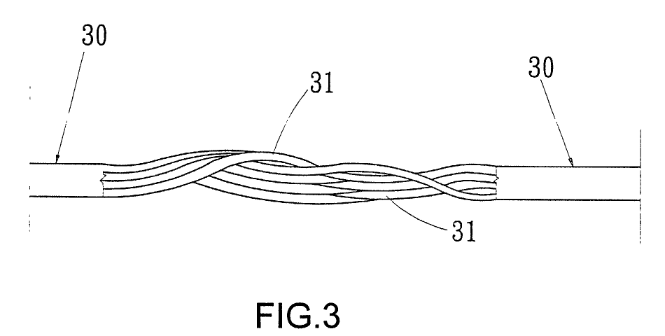

As illustrated in FIG. 2 and FIG. 3, with the present invention for arranging fiber-optic cable 30, when fiber-optic cable 30 captures the image from the rear-view of vehicle 50 and it appears on display system 40, the said image will appear in the correct form instead of in opposite mirror form. Therefore, in order to solve this problem when using fiber-optic cable 30 to capture the rear view of vehicle 50, we can twist fiber-optic line 31 approximately half-way (see FIG. 3) thereby switching the “1” position at the front of fiber-optic line 31 to be at the “A” position at the rear, the “2” position at the front to be at the “B” position in the back, the “3” position at the front to be at the “C” position at the back, and so on following this logic.

As illustrated in FIGS. 1 and 5, fiber-optic cables 30 can be evenly established around the peripheral of vehicle 50 so that the view of all sides surrounding vehicle 50 can be evenly and completely captured by fiber-optic cables 30. Also the lenses 60 on the end of fiber-optic cables 60 should be curved out to increase focus and filming scope angle thereby allowing fiber-optic cable 30 to capture a larger image.

As detailed above, the present invention combines a video camera, lens, fiber-optic cable, and a procedure reconfiguring the fiber-optic cable image thereby allowing the complete peripheral of a vehicle to be filmed by camera, after which the camera transmits the images to a display system and the driver of the vehicle can view the actual images taken by the fiber-optic cable, understand the circumstances of the area surrounding the vehicle, increase driving safety, and avoid collisions with other objects. The structure of the present invention meets patent application requirements and is hereby lawfully submitted in application thereof.

1. A fiber-optic image sensor system for automobile perimeter, wherein:
the said sensor system combines a video camera, lens, fiber-optic cable, a display system, etc, with a lens at the end of the fiber-optic cable, and a plurality of the said fiber-optic cables and optic lenses are appropriately located at different locations on a vehicle and connect to the said camera, which then connects to the said display system inside the vehicle, and the images captured by each fiber-optic cable are processed in the camera and then transmitted to the display system where they appear in order to provide the driver with the ability to the circumstances surrounding the vehicle.

2. The fiber-optic image sensor system for automobile perimeter sensing in accordance with claim 1, wherein concerning the use of fiber-optic cables to capture images from the rear of the vehicle the arrangement of the fiber-optic lines inside of the fiber-optic cable can be twisted in order to switch correspondingly in position from the right side in the front of the cable to the left side in the rear in order to solve the problem of the image appearing in mirrored opposite form.

3. The fiber-optic image sensor system for automobile perimeter as described in accordance with claim 1, wherein the fiber-optic cables are evenly positioned on the vehicle so that images of all sides surrounding the vehicle may be captured by the fiber-optic cables.

4. The fiber-optic image sensor system for automobile perimeter as described in accordance with claim 1, wherein the lens on the end of the fiber-optic cables is curved to facilitate increased focus and filming scope angle thereby allowing fiber-optic cable to capture a larger image.
